(19) United States
(12) Patent Application Publication
(10) Pub. No.: US 2023/0204851 A1
(43) Pub. Date: Jun. 29, 2023

(54) MULTI-CORE OPTICAL FIBER

(71) Applicant: Sterlite Technologies Limited, Gurugram (IN)

(72) Inventors: Srinivas Reddy Munige, Gurugram (IN); Apeksha Malviya, Gurugram (IN); Anand Pandey, Gurugram (IN)

(73) Assignee: Sterlite Technologies Limited, Gurugram (IN)

(21) Appl. No.: 17/698,812

(22) Filed: Mar. 18, 2022

(30) Foreign Application Priority Data
Dec. 28, 2021 (IN) 202111061335

(51) Int. Cl. G02B 6/02

(52) U.S. Cl. CPC G02B 6/02042

(57) ABSTRACT

Disclosed is a multi-core optical fiber including a plurality of cores extending parallelly along a central axis of the multi-core optical fiber, and defining a plurality of spatial paths such that each core of the plurality of cores has a refractive index profile having a predefined core alpha value in a range from about 5 to about 9. A core pitch between each pair of cores of the plurality of cores is in a range from about 35 micrometres to about 45 micrometres. Further, at least one core of the plurality of cores has (i) a refractive index profile different from other cores of the plurality of cores, and (ii) a core diameter different from the other cores of the plurality of cores.

### TECHNICAL FIELD

The present disclosure relates generally to optical fibers, and, more particularly, to a multi-core optical fiber.

### BACKGROUND

In optical fiber technology, single mode fibers (SMFs) are designed for transmission of a single mode of light as a carrier to propagate at a time. However, such SMFs have associated bandwidth limitations. Additionally, such SMFs exhibit non-linear effects due to increase in the data transmission rate beyond a transmission capacity limit. The non-linear effects can further result in low optical signal to noise ratio (OSNR). However, bandwidth limitations can be reduced by designing multi-core optical fibers that have multiple glass cores to transmit multiple optical signals. Additionally, by increasing number of channels per fiber and by optimizing the number of cores and a design of the multi-core optical fiber the bandwidth limitations can be reduced. The multi-core optical fibers can have multiple glass cores that are surrounded by a glass cladding. Generally, an alpha value of the refractive index profile of the core has a significant impact on distribution of light inside the core and thus effects an effective refractive index of guiding modes in the optical fibers.

The prior art reference WO2020149158A1 discloses a multicore optical fiber which has a standard clad diameter with four unimodal cores arranged therein that exhibits excellent mass productivity, quality, and yield while satisfying a desired specification. The prior art reference WO2020105470A1 discloses a multicore optical fiber having four cores with a clad diameter standard of 125±1 micrometers (μm) which is capable of coping with transmission over a distance of several thousands of kilometers. However, the multicore optical fibers disclosed in the prior art references have higher sensitivity to dispersion. The higher sensitivity to dispersion can stretch or flatten an initially sharply defined binary pulses of information. Such degradation can make the optical signals (1 s and 0 s) more difficult to distinguish from each other at the far end of the multicore optical fiber.

Thus, there is a need for a technical solution that overcomes the aforementioned problems of conventional multi-core optical fibers.

### SUMMARY

In an aspect of the present disclosure, a multi-core optical fiber is disclosed. The multi-core optical fiber has a plurality of cores extending parallelly along a central axis of the multi-core optical fiber, and defining a plurality of spatial paths such that each core of the plurality of cores has a refractive index profile having a predefined core alpha value in a range from about 5 to about 9. The plurality of cores have an even number of the cores. Further, a core pitch between each pair of cores of the plurality of cores is in a range from about 35 micrometers to about 45 micrometers. Furthermore, at least one core of the plurality of cores has (i) a refractive index profile different from other cores of the plurality of cores, and (ii) a core diameter different from the other cores of the plurality of cores. The multi-core optical fiber further have a cladding layer that surrounds an outer circumferential surface of each core of the plurality of cores, wherein the cladding layer has an inner cladding and an outer cladding. An outer cladding thickness of the outer cladding is greater than or equal to 30 micrometers (μm). The cladding layer has a diameter in a range from about 100 μm to about 300 μm. the multi-core optical fiber further have a coating layer that surrounds the cladding layer, wherein a coating diameter of the coating layer is in a range from about 160 μm to about 500 μm.

### BRIEF DESCRIPTION OF DRAWINGS

The following detailed description of the preferred aspects of the present disclosure will be better understood when read in conjunction with the appended drawings. The present disclosure is illustrated by way of example, and not limited by the accompanying figures, in which like references indicate similar elements.

FIG. 1 illustrate a cross-sectional view of a multi-core optical fiber.

FIG. 2 illustrates a cross-sectional view of a multi-core optical fiber.

### DETAILED DESCRIPTION

The detailed description of the appended drawings is intended as a description of the currently preferred aspects of the present disclosure, and is not intended to represent the only form in which the present disclosure may be practiced. It is to be understood that the same or equivalent functions may be accomplished by different aspects that are intended to be encompassed within the spirit and scope of the present disclosure.

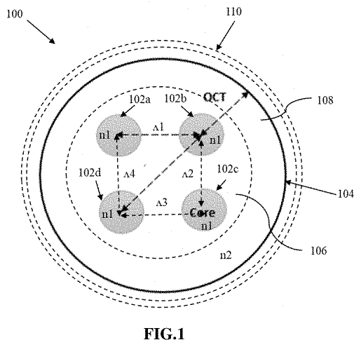

FIG. 1 illustrates a cross-sectional view of a multi-core optical fiber 100, in accordance with an aspect of the present disclosure. As illustrated in FIG. 1, the multi-core optical fiber 100 can have a plurality of cores 102 of which a first through fourth cores 102a, 102b, 102c and 102d (hereinafter interchangeably referred to and designated as “the plurality of cores 102”) are shown, a cladding layer 104, and a coating layer 106. The first through fourth cores 102a, 102b, 102c and 102d can be arranged parallel to a central axis CX of the multi-core optical fiber 100 such that the first through fourth cores 102a, 102b, 102c and 102d run longitudinally, (i.e., parallel to the central axis CX). As illustrated in FIG. 1, the multi-core optical fiber 100 can be designed to employ space division multiplexing (SDM) technique to transmit a plurality of optical signals through a plurality of spatial paths defined by the first through fourth cores 102a, 102b, 102c and 102d simultaneously. The plurality of spatial paths defined by the first through fourth cores 102a, 102b, 102c and 102d are capable of carrying the plurality of optical signals within the multi-core optical fiber 100. Further, the simultaneous transmission of the plurality of optical signals through the plurality of cores 102 exponentially increases a transmission capacity of the multi-core optical fiber 100. In an aspect, the multi-core optical fiber 100 can be manufactured by isotropically and/or anisotropically distributing the first through fourth cores 102a, 102b, 102c and 102d in the same optical fiber (i.e., the multi-core optical fiber 100).

It will be apparent to a person skilled in the art that the multi-core optical fiber 100 is shown to have four cores (i.e., the first through fourth cores 102a, 102b, 102c and 102d) to make the illustrations concise and clear and should not be considered as a limitation of the present disclosure. In various other aspects, the multi-core optical fiber 100 can have more than four cores i.e., the multi-core optical fiber 100 can have an even number of cores, without deviating from the scope of the present disclosure. In such scenario, the plurality of cores 102 can have two or more cores.

The plurality of cores 102a through 102d can be arranged in a predefined symmetrical lattice on the cross-section that is perpendicular to an axis extending parallelly along the central axis CX of the multi-core optical fiber 100. In an aspect, the predefined symmetrical lattice can be a hexagonal lattice. In the illustrated aspect of FIG. 1, the predefined symmetrical lattice is a square lattice. As used herein “the symmetrical lattice” refers to the arrangement of the first through fourth cores 102a, 102b, 102c and 102d in a manner such that first through fourth cores 102a, 102b, 102c and 102d are arranged corresponding to each other and/or around the central axis CX, thus defining symmetry.

It will be apparent to a person skilled in the art that the first through fourth cores 102a, 102b, 102c and 102d are shown to be arranged in the square lattice to make the illustrations concise and clear and should not be considered as a limitation of the present disclosure. In various other aspects, the first through fourth cores 102a, 102b, 102c and 102d can be arranged in any type of the predefined symmetrical lattice, without deviating from the scope of the present disclosure.

The plurality of cores 102a through 102d can be arranged in a predefined symmetrical lattice on the cross-section that is perpendicular to an axis extending parallelly along the central axis CX of the multi-core optical fiber 100. In an aspect, the predefined lattice can be a hexagonal lattice. In the illustrated aspect of FIG. 1, the predefined lattice is a square lattice. It will be apparent to a person skilled in the art that the cores 102a through 102d are shown to be arranged in the square lattice to make the illustrations concise and clear and should not be considered as a limitation of the present disclosure. In various other aspects, the cores 102a through 102d can be arranged in any type of the predefined lattice, without deviating from the scope of the present disclosure. The first through fourth cores 102a, 102b, 102c and 102d can be designed to guide the plurality of optical signals. The first through fourth cores 102a, 102b, 102c and 102d may be a cylindrical fiber that may run along a length of the multi-core fiber 100. The first through fourth cores 102a, 102b, 102c and 102d may be made up of a material selected from at least one of, a plastic, a pure silica glass, a doped silica glass, and the like. Aspects of the present disclosure are intended to cover any type of the material for the first through fourth cores 102a, 102b, 102c and 102d, including known, related and later developed materials known to a person of ordinary skill in the art.

Each core of the first through fourth cores 102a, 102b, 102c and 102d may define a spatial path such that each spatial path defined by each core facilitates in carrying the optical signal. Further, each core of the first through fourth cores 102a, 102b, 102c and 102d may have an associated refractive index profile. As used herein, the “refractive index profile” is a relationship between a refractive index or a relative refractive index and optical fiber radius of the multi-core optical fiber 100. Further, the refractive index profile may have a predefined core alpha value. The predefined core alpha value is in a range of 5 to 9. According to aspects of the present disclosure, the predefined core alpha value may be selected in the range of 5 to 9 as core alpha value below 5 can make the multi-core optical fiber 100 highly dispersion sensitive. On the other hand, the predefined core alpha value beyond 9 can reduce a dispersion sensitivity of the multi-core optical fiber 100, however, such high values for the predefined core alpha value makes manufacturing process difficult for the multi-core optical fiber 100, therefore, the predefined core alpha value for the multi-core optical fiber 100 is selected in the range of 5 to 9. The predefined core alpha value of each core of the first through fourth cores 102a, 102b, 102c and 102d facilitates in providing a lower sensitivity to dispersion for the multi-core optical fiber 100. Further, the predefined core alpha value may facilitate to attain a mode field diameter (MFD) in a range of 7.9 micrometers (μm) to 9.5 μm at an operating wavelength of 1550 nanometers (nm) and 1310 nm (as will be discussed below).

In the illustrated aspect of FIG. 1, the first through fourth cores 102a, 102b, 102c and 102d can have a circular shape. It will be apparent to a person skilled in the art that the first through fourth cores 102a, 102b, 102c and 102d are shown to have the circular shape to make the illustrations concise and clear and should not be considered as a limitation of the present disclosure. In various other aspects, the first through fourth cores 102a, 102b, 102c and 102d can have any type of shape such as, but not limited to, an oval shape, a hexagonal shape, a triangular shape, an irregular shape, and the like, without deviating from the scope of the present disclosure.

Further, the first through fourth cores 102a, 102b, 102c and 102d can have a core radius that is in a range from 3 micrometers (μm) to 4 μm. Thus, the first through fourth cores 102a, 102b, 102c and 102d can have a core diameter that is in a range from 6 μm to 8 μm. In an aspect, at least one core of the first through fourth cores 102a, 102b, 102c and 102d may have at least one of, a refractive index profile different from a refractive index profile of the other cores of the first through fourth cores 102a, 102b, 102c and 102d and a core diameter different from a core diameter of the other cores of the first through fourth cores 102a, 102b, 102c and 102d to ensure mixing of signals in the multi-core optical fiber 100. In one aspect, the core diameter of the first core 102a may be 6 μm and the core diameter of the second through fourth cores 102b, 102c, and 102d may be 8 μm. In another aspect, the core diameter of the first core 102a may be 6 μm and the core diameter of the second and third cores 102b and 102c may be 8 μm. In another aspect, each of the first through fourth cores 102a, 102b, 102c and 102d may not have the same refractive index and may not have the same refractive index profile. In an example, the first core 102a, the second core 102b, the third core 102c, and the fourth core 102d has a first refractive index profile, a second refractive index profile, a third refractive index profile, and a fourth refractive index profile, respectively. The first refractive index profile, the second refractive index profile, and the third refractive index profile of the first core 102a, the second core 102b, and the third core 102c, respectively are same. However, the fourth refractive index profile of the fourth core 102d is different than the first refractive index profile, the second refractive index profile, the third refractive index profile. Further, the first core 102a, the second core 102b, the third core 102c, and the fourth core 102d has a first core diameter, a second core diameter, a third core diameter, and a fourth core diameter, respectively. A numerical value of the first core diameter, the second core diameter and the third core diameter are equal. However, a numerical value of the fourth core diameter can be different from the numerical value of the first core diameter, the second core diameter and the third core diameter. In one aspect of the present disclosure, the predefined core alpha value of the refractive index profile associated with the first core 102a may be 7 while the predefined core alpha value of the refractive index profiles associated with the second through fourth cores 102b, 102c, and 102d may be 8. In another aspect, the predefined core alpha value of the refractive index profile associated with the first core 102a may be 9 while the predefined core alpha value of the refractive index profiles associated with the second through fourth cores 102b, 102c, and 102d may be 5. The different predefined core alpha value of the refractive index profiles of the first through fourth cores 102a, 102b, 102c, and 102d may be selected to ensure prevention of mixing of signals in the multi core optical fiber 100.

In the illustrated aspect of FIG. 1, each pair of the cores of the first through fourth cores 102a, 102b, 102c and 102d may have a predefined core pitch. Specifically, the predefined core pitch can be in a range from 35 μm to 45 μm. In an example, the first core 102a and the adjacent second core 102b has a first core pitch Λ1, the second core 102a and the adjacent third core 102b has a second core pitch Λ2, the third core 102c and the adjacent fourth core 102d has a third core pitch Λ3, and the fourth core 102d and the adjacent first core 102a has a fourth core pitch Λ4. As used herein, “the first through fourth core pitch Λ1 through Λ4” are distance between each pair of the cores of the plurality of cores 102a through 102d. Specifically, a numerical value of the first through fourth core pitch Λ1 through Λ4 is in a range from about 35 μm to about 45 μm. In an aspect, the numerical value of the first through fourth core pitch Λ1 through Λ4 can be same. In another aspect, the numerical value of the first through fourth core pitch Λ1 through Λ4 can be different. In an example, the first core pitch Λ1 may be 37 μm while the second through fourth core pitch Λ2 through Λ4 may be 40 μm. In another example, the first core pitch Λ1 may be 35 μm, the second core pitch Λ2 may be 40 μm while the third and fourth core pitch Λ3 and Λ4 may be 45 μm.

Further, the multi-core optical fiber 100 has a cladding layer 104 that may surround an outer circumferential surface of the plurality of cores 102 (i.e., the first through fourth cores 102a, 102b, 102c and 102d). Specifically, the cladding layer 104 may have an inner cladding 108 and an outer cladding 110. The inner cladding 108 is provided in a way that the inner cladding 108 envelops the outer circumferential surface of the plurality of cores 102 (i.e., the first through fourth cores 102a, 102b, 102c, and 102d) with no gap between an outer surface of each of the first through fourth cores 102a, 102b, 102c, and 102d and the inner cladding 106. The inner cladding 108 may be made up of silica glass with a doping of at least one of, chlorine and fluorine. In one aspect, the inner cladding 108 can be made up of the silica glass such that a refractive index of the inner cladding 108 can decreased by adding a dopant such as fluorine (F). In another aspect, the inner cladding 108 can be made up of the silica glass such that the refractive index of the inner cladding 108 can be increased by adding a dopant such as chlorine (Cl). The refractive index of the inner cladding 108 can be manipulated to ensure restriction of the light signal well within the first through fourth cores 102a, 102b, 102c, and 102d of the multi-core optical fiber 100.

The outer cladding 110 may be provided in a way that the outer cladding 110 envelops an outer circumferential surface of the plurality of cores 102 (i.e., the first through fourth cores 102a, 10/2b, 102c, and 102d). The outer cladding 110 may be configured to restrict the light signal well within the first through fourth cores 102a, 102b, 102c, and 102d in order to prevent mixing up of cores in the multi-core optical fiber 100. Specifically, the outer cladding 110 may envelop an outer circumferential surface of the inner cladding 108 such that there exists no gap between the outer surface of the inner cladding 108 and an inner surface of the outer cladding 110. The outer cladding 100 can be made up of pure silica glass. Further, a refractive index of the outer cladding 110 can be adjusted by adding a dopant such as, but not limited to, germanium (Ge), fluorine (F), and the like.

In an aspect, the outer cladding 108 can have an associated outer cladding thickness (OCT) that may be greater than or equal to 30 μm. In an example, the OCT can be a distance from the center of any of the core of the plurality of cores 102 to an interface of the outer cladding 110 with the coating 106 (as will be discussed below). As illustrated in FIG. 1, the cladding layer 104 may have an associated cladding diameter that has a thickness of the inner cladding 108 and the outer cladding 110. In an aspect, the cladding diameter can be in a range from 100 μm to 300 μm.

The cladding layer 104 may have an associated refractive index that may be less than the refractive index of each of the core of the plurality of cores 102. In an example, the refractive index of each of the core of the plurality of cores 102 can be n1 and the refractive index of the cladding layer 104 can be n2 such that n2 is less than n1. In an aspect, a relative refractive index Δ1 which is the comparative refractive index between at least one core of the plurality of cores 102 having the refractive index n1 with the cladding layer 104 having the refractive index n2 can be 0.5%. Further, a maximum relative refractive index Δ1max which is the comparative refractive index between at least one core of the plurality of cores 102 having the refractive index n1 with the cladding layer 104 having the refractive index n2 can be 0.5%.

The multi-core optical fiber 100 further has the coating layer 106. The coating layer 106 can have one or more coatings of which a primary coating 106a and a secondary coating 106b are shown. It will be apparent to a person skilled in the art that the coating layer 106 is shown to have the primary coating 106a and the secondary coating 106b to make the illustrations concise and clear and should not be considered as a limitation of the present disclosure. In various other aspects, the coating layer 106 can have any number of layers similar to the primary layer 106a and/or the secondary layer 106b without deviating from the scope of the present disclosure. In an aspect, the primary coating 106a can be made up of an ultraviolet (UV) light curable resin which is formed of, for example, a first colored material. In another aspect, the primary coating 106a and the secondary coating 106b can have the UV light curable acrylate mixture of monomers, oligomers, photo initiators, and additives, such that the mixtures are cured separately. The coating layer 106 may have an associated coating diameter. The coating diameter of the coating layer 106 can be in a range from 160 μm 500 μm.

In one aspect of the present disclosure, for the first through fourth core 102a, 102b, 102c and 102d, the relative refractive index is between 0.37 and 0.4%, the core radius of each core of the plurality of cores 102a, 102b, 102c and 102d is between 3.42 and 3.77 μm, the core alpha is between 6 and 9, the cladding diameter of the cladding layer 104 is between 120 and 250, the coating diameter of the coating layer 110 of the multi-core optical fiber 100 is between 160 μm and 500 μm, and the outer cladding thickness (OCT) of the outer cladding 108 is 32.1 μm. In relation to the above aspects of the disclosure, the core pitch is between 40 and 45 μm. The multi-core optical fiber 100 fabricated based on above numerical values may have a crosstalk between −32 decibel/kilometer (dB/km) and −56 dB/km, at 140 millimeters (mm) bend condition of the multi-core optical fiber 100 and at a transmission length of 30 km, the MFD at the wavelength of 1550 nm between 9.36 μm and 9.6 μm, the MFD at the wavelength of 1310 nm between 7.98 μm and 8.33 μm, a cable cut-off between 1122 nm and 1219 nm, a zero-dispersion wavelength (ZDW) between 1339.4 nm and 1360 nm, an attenuation of the multi-core optical fiber 100 at a wavelength of 1310 nm is less than 0.35 db/km, an attenuation of a cable formed by using the multi-core optical fiber 100 at a wavelength of 1310 nm is less than 0.4 db/km, the attenuation of the multi-core optical fiber 100 at a wavelength of 1550 nm is less than 0.25 db/km, and the attenuation of the cable formed by using the multi-core optical fiber 100 at a wavelength of 1550 nm is less than 0.3 db/km.

Thus, the multi-core optical fiber 100 of the present disclosure can be configured to transmit multiple optical signals through the parallel spatial paths defined by the plurality of cores 102 simultaneously. Hence, the data transmission capacity of the cable manufactured using the multi-core optical fiber 100 is increased. Further, the multi-core optical fiber 100 of the present disclosure has the core alpha value in the range of 5 to 9 that facilitates in establishing a good control over confinement and to attaining the MFD at the wavelength of 1550 nm and 1310 nm in a range of 9.1±0.5 micrometer (μm) and 8.1±0.5 μm, respectively.

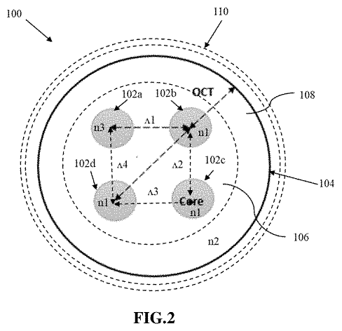

FIG. 2 illustrates a cross-sectional view of a multi-core optical fiber 200. The multi-core optical fiber 200 is similar to the multi-core optical fiber 100 with like elements referenced with like numerals. However, the multi-core optical fiber 200 may have the plurality of cores 102 with different values of the refractive indexes as compared to the multi-core optical fiber 100. Specifically, the refractive index of one core (e.g., the first core 102a) of the plurality of cores 102 may have a refractive index n3 while the other cores (e.g., the second through fourth cores 102b, 102c, 102d) may have the refractive index of n1. In such examples, the refractive index of the cladding layer can be n2.

While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims. Further, unless stated otherwise, terms such as “first” and “second” are used to arbitrarily distinguish between the elements such terms describe. Thus, these terms are not necessarily intended to indicate temporal or other prioritization of such elements.

What is claimed is:

1. A multi-core optical fiber, comprising:
a plurality of cores extending parallelly along a central axis of the multi-core optical fiber, and defining a plurality of spatial paths such that each core of the plurality of cores has a refractive index profile having a predefined core alpha value in a range from 5 to 9; and
wherein at least one core of the plurality of cores has at least one of (i) a refractive index profile different from other cores of the plurality of cores, and (ii) a core diameter different from the other cores of the plurality of cores.

2. The multi-core optical fiber of claim 1, wherein a core pitch between each pair of cores of the plurality of cores is in a range from 35 micrometres (μm) to 45 μm.

3. The multi-core optical fiber of claim 1, wherein the plurality of cores has an even number of the cores.

4. The multi-core optical fiber of claim 1, further comprising a cladding layer having has an inner cladding and an outer cladding, wherein the inner cladding envelops the outer circumferential surface of each core of the plurality of cores, and wherein the outer cladding envelops an outer circumferential surface of the inner cladding., wherein an outer cladding thickness of the outer cladding is greater than or equal to 30 micrometres (μm).

5. The multi-core optical fiber of claim 4, wherein the cladding layer has a diameter in a range from 100 μm to 300 μm.

6. The multi-core optical fiber of claim 4, further comprising a coating layer that envelops the cladding layer, wherein a coating diameter of the coating layer is in a range from 160 μm to 500 μm.

7. The multi-core optical fiber of claim 1, wherein a maximum relative refractive index Δ₁max between each core of the plurality of cores and the cladding layer is 0.5%.

8. The multi-core optical fiber of claim 1, wherein each core of the plurality of cores has a shape selected from at least one of, a circular shape, an oval shape, a hexagonal shape, a triangular shape, and an irregular shape.
